(19) United States
(12) Patent Application Publication
(10) Pub. No.: US 2025/0359963 A1
(43) Pub. Date: Nov. 27, 2025

(54) INVISIBLE DAM

(71) Applicant: The Invisible Dam LLC, Bronx, NY (US)

(72) Inventors: Alan Bennett Rosenthal, Bronx, NY (US); Martin Rosenthal, Bronx, NY (US)

(21) Appl. No.: 19/036,625

(22) Filed: Jan. 24, 2025

Related U.S. Application Data
(60) Provisional application No. 63/624,318, filed on Jan. 24, 2024.

(51) Int. Cl. A61C 5/82

(52) U.S. Cl. CPC A61C 5/82; A61C 2203/00

(57) ABSTRACT

The present invention relates to a transparent dental dam designed to enhance the safety and efficiency of dental procedures by providing superior safety, comfort isolation, and protection. It features a flexible barrier sheet made from a transparent proprietary elastomeric silicone material, which can be custom perforated to fit around individual teeth. The dental dam is used in combination with a tension clamp or ring to secure it firmly in place, along with a peripheral frame that maintains the barriers' position and structural integrity. This design prevents the aspiration of debris, reduces the risk of choking, gagging, and swallowing dental materials, and minimizes bacterial contamination from saliva. By addressing the limitations of traditional dental dams, the invention offers a more adaptable, secure, and comfortable solution, improving both patient safety and procedural effectiveness.

This application claims the benefit of the filing date of U.S. Patent Application No. 63/624,318, filed on Jan. 24, 2024, the entirety of which is incorporated herein by reference.

### BACKGROUND

Dental procedures require highly specialized tools to ensure both patient safety and the effectiveness of treatments. Traditional dental dams, crucial for isolating the treatment area and protecting oral tissues, often face significant limitations. Conventional rubber dams often obscure the dentist's view of the oral cavity, limiting visibility to only the specific tooth or teeth during dental treatment. This can hinder the ability of a health provider to safely monitor and visualize surrounding intraoral areas such as the throat, pharynx, dentition, and tongue. The use of latex material in other dental rubber dams also poses a risk of allergic reactions for some patients, adding another layer of complexity to their use.

Current designs also lack the adaptability needed to accurately fit various tooth sizes and shapes. This inflexibility can result in gaps or improper coverage, increasing the risk of debris.

Embodiments of the present invention seek to address these problems by introducing a dental dam with a flexible, custom-perforable barrier sheet made from a hypoallergenic polymer such as polyisoprene. This material choice, combined with an integrated elastic peripheral frame, provides improved adaptability, comfort, and structural support. The design ensures a secure fit around individual teeth, minimizes contamination risks, and enhances dental treatments' overall safety and efficacy.

An object of the present disclosure is to provide a dental dam with improved flexibility and adaptability for various tooth sizes and shapes.

Another object of the present disclosure is to enhance patient safety by minimizing the risk of aspiration or ingestion of dental materials.

Another object of the present disclosure is to reduce bacterial contamination by creating a more reliable and secure isolation barrier.

Another object of the present disclosure is to offer a hypoallergenic alternative to traditional latex dental dams for patients with sensitivities.

Still another object of the present disclosure is to improve the ease of installation and adjustment during dental procedures.

Another variation of this product is facilitated by an optional designated quadrant outline marked on the rubber dam, simplifying the process of determining where to perforate according to the specific teeth or tooth being treated.

Yet another object of the present disclosure is to enhance overall patient comfort through a well-fitting design.

Other objects and advantages of the present disclosure will be more apparent from the following description, which is not intended to limit the scope of the present disclosure.

### SUMMARY OF THE INVENTION

The present invention is a dental dam designed to improve the safety and efficacy of dental procedures significantly. It features a flexible barrier sheet made from hypoallergenic polyisoprene, which can be custom perforated to fit snugly around individual teeth, accommodating various sizes and shapes. The dental dam includes a tension clamp or ring to secure the dam firmly, ensuring a reliable seal that isolates the treatment area from the rest of the oral cavity. This innovative design aims to reduce the risk of aspiration, ingestion, or contamination, while also enhancing patient comfort and procedural efficiency. By addressing the limitations of traditional dental dams, the invention offers a more adaptable, secure, and patient-friendly solution for dental isolation.

Another embodiment of the present invention features a dental dam crafted from a proprietary elastomeric hypoallergenic silicone material noted for its flexibility, waterproof, and tear-resistant properties. This innovative material is transparent, odor-free, and resistant to chloroform, offering enhanced durability, safety, and comfort. It presents a superior alternative to traditional latex dental dams.

Yet another embodiment of the present invention is the barrier sheet can be perforated on-site using a hole puncher to fit specific teeth, ensuring a tailored and secure fit during dental procedures.

Yet another embodiment of the present invention is the dental dam is secured to the tooth using tension clamps or rings, which conform to the tooth's anatomy, providing a reliable seal and maintaining a sterile environment.

Yet another embodiment of the present invention is the dental dam protects the patient's oral tissues, preventing aspiration, bacterial contamination, and the loss of dental materials or equipment.

Another embodiment of the present invention introduces a dental dam designed to safeguard and monitor the patient's intraoral anatomic structures. This dam enhances a patient's safety by preventing aspiration, bacterial contamination, and the misplacement of dental materials or equipment, due to its unique design allowing visibility and transparency. These features allow practitioners to clearly observe and promptly address issues such as the pooling of saliva in the back of the throat, causing difficulty swallowing, which can lead to gagging, choking, and disruption of treatment. This innovative distinction and alternative characteristic enable the capability to monitor and respond to such concerns in real-time which is not available with traditional dental dams currently available and in use.

Yet another embodiment of the present invention is dam is versatile and can be adjusted to fit various patient anatomies and different dental procedures, enhancing its usability.

Yet another embodiment of the present invention is the design that facilitates quick application and removal, improving procedural efficiency and minimizing discomfort for the patient.

### BRIEF DESCRIPTION OF THE DRAWINGS

The features and advantages of the present disclosure will be more fully understood with reference to the following detailed description when taken in conjunction with the accompanying figures, wherein:

FIG. 1 illustrates one embodiment of the dental dam, showcasing its overall structure and design.

FIG. 2 depicts one embodiment of the dental dam fitted over a patient's mouth, illustrating its positioning to cover the treatment area while ensuring isolation of the operative field and providing a secure, comfortable fit.

FIG. 3 illustrates one embodiment of the dental dam with a perforation punched in the barrier sheet to accommodate a specific tooth. It shows the dam positioned around the tooth, with the perforation enabling proper alignment and secure attachment using a tension clamp or ring.

FIG. 4 depicts one embodiment of a dental dam barrier sheet incorporating an integrated demarcation template for precise tooth alignment and hole placement.

### DETAILED DESCRIPTION

The following description is of exemplary embodiments only and is not intended to limit the scope, applicability, or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

The present invention relates to an improved dental dam designed to enhance the safety, cleanliness, comfort, and efficiency of dental procedures. The dental dam is specifically engineered to provide a transparent protective barrier that isolates the operative field within a patient's oral cavity, thereby minimizing the risk of contamination, leakage of saliva or irrigation chemicals, aspiration of dental materials, or accidentally misplaced instruments.

The barrier sheet is typically made of a proprietary transparent elastomeric silicone hypoallergenic material known for its strength, elasticity, and impermeability. This material offers several advantages over traditional latex materials, including enhanced comfort for patients with latex allergies and greater adaptability to the contours of the oral cavity. The sheet can be perforated to fit around one or more teeth, creating a sealed environment that isolates the operative site.

The barrier sheet is designed to accommodate a perforation, which can be created using a rubber dam hole puncher. This perforation is intended to receive the tooth of the patient, ensuring that the dam remains securely in place during the procedure. The sheet's flexibility allows it to conform to the shape of the teeth and surrounding oral tissues, thereby providing a reliable seal that prevents contaminants from entering or exiting the operative field.

To secure the dental dam around the exposed tooth or teeth, embodiments of the invention may as an option include tension devices, such as clamps or rings. These devices are designed to apply controlled pressure to hold the dam in place without causing discomfort to the patient. Tension clamps are typically made from resilient materials that allow them to deform temporarily during placement and then return to their original shape to exert a clamping force. The design of these clamps may vary to accommodate different tooth shapes and sizes, ensuring a secure fit in a wide range of clinical scenarios.

Tension rings, on the other hand, are generally circular or oval and are designed to maintain the dental dam in a stretched position around a tooth. These rings are constructed from materials that allow them to expand and contract, providing a holding force that secures the dam in place. The tension rings may include grips or handles to aid in their placement and removal by the dental practitioner.

Embodiments of the invention allow for a high degree of adaptability and customization to suit various dental procedures and patient needs. This transparent barrier sheet can be manufactured in different thicknesses, providing varying levels of durability and tactile sensitivity based on the specific requirements of the procedure.

Alternative embodiments of the dental dam may as an option offer pre-cut designs that fit more anatomically to the patient's mouth, further simplifying the setup process. The hole puncher used to create perforations in the sheet could be designed with interchangeable heads to produce perforations of different sizes, allowing for greater flexibility in accommodating different tooth sizes.

The tension devices, such as clamps and rings, may also feature ergonomic enhancements to improve ease of use and patient comfort.

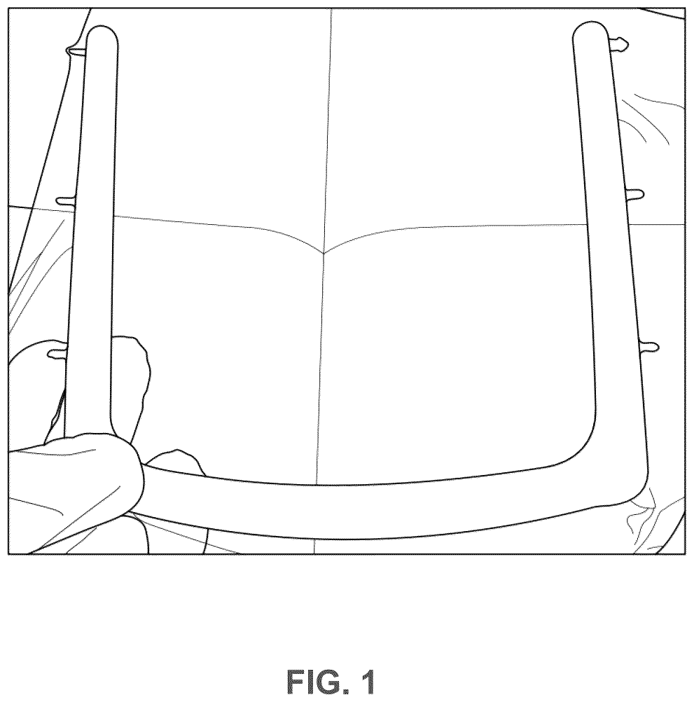

The dental dam as shown in FIG. 1 is designed to enhance the safety, cleanliness, and efficiency of dental procedures. It serves as a transparent and protective barrier for the patient's oral tissues, such as the lips, floor of the mouth, throat, pharynx, and tongue, during dental treatments. Specifically, the dental dam (FIG. 1) is configured to prevent several potential hazards, including the aspiration of saliva, particulate matter, dental materials, instruments, equipment, or bacterial contamination. Aspiration into the respiratory system (lungs), of foreign materials can result in serious life-threatening injury.

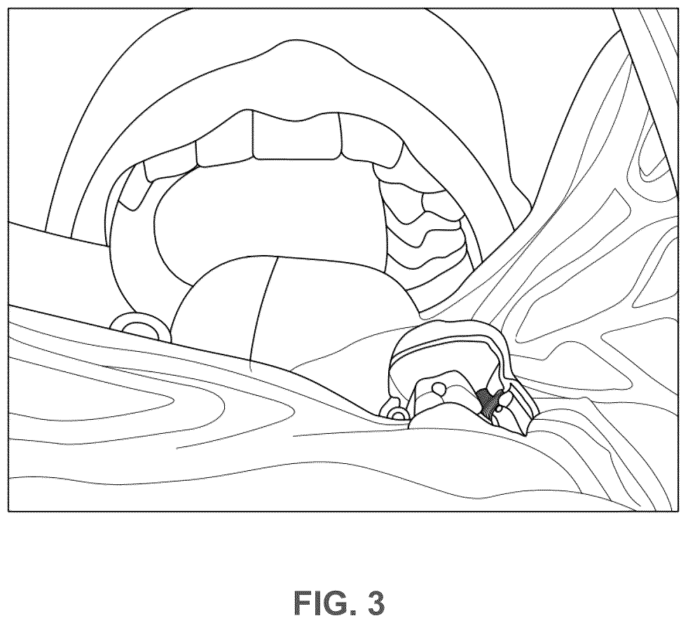

This dental dam is a flexible, resilient barrier sheet (FIG. 1) that is designed to isolate the area of the treatment from the rest of the oral cavity. This barrier sheet can be perforated using a hole puncher to accommodate one or more teeth (FIG. 3). This transparent barrier sheet is secured around the designated tooth or teeth using a tension device, such as a tension clamp or a tension ring (FIG. 3). The tension rings/clamps are devices designed to conform to various parts of the tooth, including the neck, crown, or root, creating a sealed environment that isolates the operative field from the rest of the oral cavity. This feature enables dental professionals to work within a defined space, thereby enhancing the effectiveness and cleanliness of the treatment while improving patient safety.

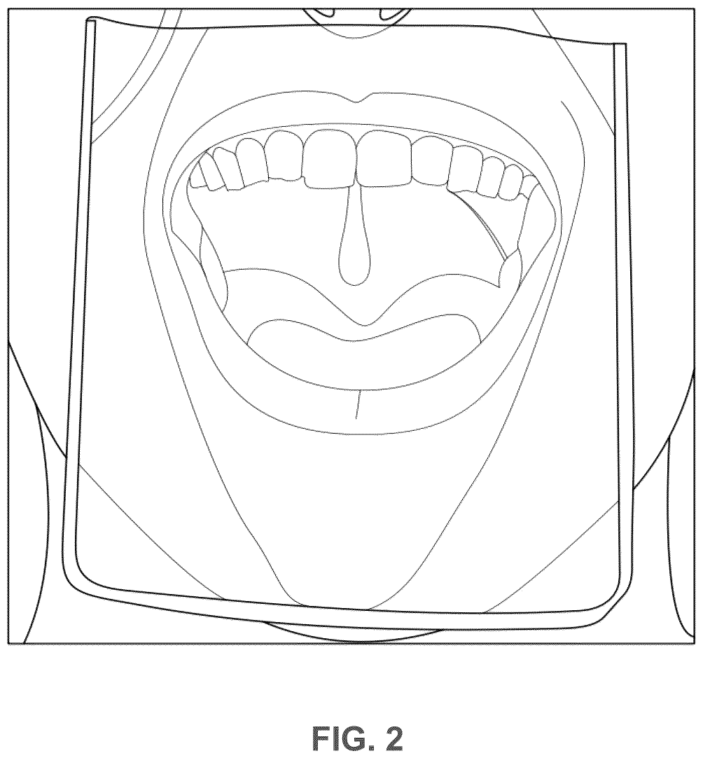

In preparation for treatment, the dental dam is placed over the patient's open mouth, with the transparent barrier sheet covering the desired area (FIG. 2). The practitioner selects the appropriate site for perforation, creates a hole using a hole puncher (FIG. 3), and then passes the tooth or teeth through the perforation(s) around the tension clamp or ring is then applied to secure the dam around the base of the tooth, effectively isolating the operative site. A dental rubber dam frame is then attached to the barrier.

The disclosed dental dam offers several technical advantages over conventional rubber dams and dental isolation devices: transparency, non-latex, waterproof, odor-free, and chloroform-resistant.

By creating a sealed environment within the oral cavity, the dental dam minimizes the risk of contamination, reduces the likelihood of procedural complications, and improves the overall quality of care provided to the patient.

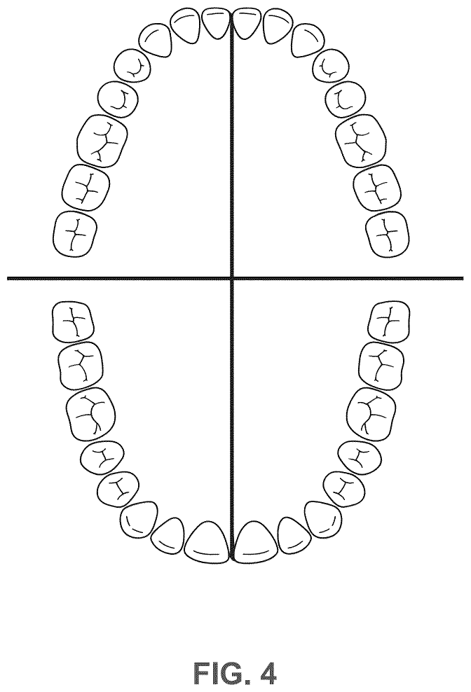

An optional feature of the present invention includes a template or teeth demarcations (FIG. 4) provided on each barrier or as a separate guide included in the packaging. These demarcations or templates assist practitioners in precisely locating and punching holes in the barrier to match the anatomical arrangement of a patient's teeth. By providing a clear and easy-to-follow guide, this feature minimizes guesswork, reduces preparation time, and ensures the barrier fits securely around the treatment area. The template may also include quadrant-specific markings, simplifying the process for targeting specific teeth or regions of the oral cavity.

In another embodiment, the barrier sheet incorporates micro holes strategically designed to facilitate airflow and enhance patient comfort during use. These micro holes are sufficiently small to prevent the passage of saliva, liquids, or other contaminants into or out of the oral cavity due to the surface tension of the materials involved. This innovative feature allows patients to breathe more comfortably without compromising the barrier's effectiveness in isolating the treatment area. The micro-hole design is particularly beneficial for extended procedures, improving overall patient experience while maintaining a sterile environment.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A dental dam comprising:
a flexible, resilient barrier sheet made of a biocompatible elastomeric material configured to isolate a dental work area from the rest of the oral cavity;
at least one perforation in the barrier sheet, created to accommodate one or more teeth, wherein the barrier sheet is secured around the tooth or teeth to create a sealed environment;
a tension device configured to secure the barrier sheet around the tooth or teeth, thereby isolating the operative site within the oral cavity; and
wherein the barrier sheet is transparent.

2. The dental dam of claim 1, wherein the barrier sheet is made of polyisoprene.

3. The dental dam of claim 1, wherein the barrier sheet is manufactured in different thicknesses to provide varying levels of durability and tactile sensitivity.

4. The dental dam of claim 1, wherein the barrier sheet is transparent or tinted to enhance visibility for the practitioner.

5. The dental dam of claim 1, wherein the barrier sheet includes a flavoring or scent to improve patient comfort.

6. The dental dam of claim 1, wherein the elastic peripheral frame is constructed from a material selected from the group consisting of metal, nylon, silicone, or thermoplastic elastomers.

7. The dental dam of claim 1, wherein the elastic peripheral frame includes adjustable features, such as hinges or segmented sections, to customize the fit to the patient's oral anatomy.

8. The dental dam of claim 1, wherein the tension device comprises a tension clamp that applies controlled pressure to secure the barrier sheet around the tooth or teeth.

9. The dental dam of claim 8, wherein the tension clamp includes a locking mechanism to maintain its position on the tooth during the procedure.

10. The dental dam of claim 1, wherein the tension device comprises a tension ring that exerts a radial inward force to maintain the barrier sheet in a stretched position around the tooth or teeth.

11. The dental dam of claim 10, wherein the tension ring includes grips or handles to facilitate placement and removal by the dental practitioner.

12. The dental dam of claim 1, wherein the perforation in the barrier sheet is created using a hole puncher with interchangeable heads for different sizes of perforations.

13. The dental dam of claim 1, wherein the barrier sheet includes preformed perforations for easier application around the teeth.

14. The dental dam of claim 1, wherein the elastic peripheral frame is designed to be removable and reusable, allowing for the barrier sheet to be replaced as needed.

15. The dental dam of claim 1, wherein the barrier sheet is designed to resist tearing and maintain its integrity during the dental procedure.

16. The dental dam of claim 1, wherein the barrier sheet and elastic peripheral frame are configured to fit a variety of mouth sizes, ensuring a comfortable fit for different patients.

17. The dental dam of claim 1, wherein the dental dam is designed to reduce the likelihood of bacterial contamination by providing a secure and isolated operative site.

18. The dental dam of claim 1, further wherein an elastic peripheral frame designed to provide structural support to the barrier sheet is provided, the frame being constructed from an elastic material that conforms to the shape and size of the oral cavity while maintaining tension on the barrier sheet.

19. A dental dam for use in a dental procedure, comprising:
a barrier sheet made of polyisoprene, configured to:
(a) have a perforation punched therethrough using a hole puncher, wherein the perforation is designed to receive a tooth of a patient;
(b) be secured to the tooth by a tension clamp or a tension ring, wherein the tension clamp or ring is adapted to the tooth's neck, crown, or root;
(c) an elastic peripheral frame configured to provide structural support to the barrier sheet, the peripheral frame comprising a material selected from the group consisting of metal and plastic;
wherein the dental dam is further configured to protect the patient's oral tissues, including the lips, mouth floor, throat, pharynx, and tongue.
